(19) United States
(12) Patent Application Publication
(10) Pub. No.: US 2007/0213005 A1
(43) Pub. Date: Sep. 13, 2007

(54) Information Distribution System Based On Public Transit System and Operation Method Thereof

(76) Inventor: Jue-Hsuan Hsiao, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/683,006

(22) Filed: Mar. 7, 2007

(30) Foreign Application Priority Data
Mar. 9, 2006 (TW) 2006-064424

(51) Int. Cl. H04B 7/15

(52) U.S. Cl. 455/11.1

(57) ABSTRACT

The present invention relates to an information distribution system based on a public transit system, which utilizes transportation vehicles of the public transit system to carry information and transmit the information to an information station near the operation route of the transportation vehicle, and the reverse information transmission for system management also is exists, so as to achieve the purpose of information distribution network.

### BACKGROUND OF THE INVENTION

1. Field of the Invention

The present invention relates to an information distribution system and method thereof, and more particularly to an electronic information distribution system, which utilizes transportation vehicles of the public transit system to transmit the information to each station of the transit network of the public transit system.

2. Description of the Prior Art

Nowadays, the public information distribution utilizes the mediums such as wired and wireless television distribution systems, telecommunication distribution system, and Internet. The wireless television distribution system requires establishing a broadcast transmitting station. The wired television distribution system requires coaxial cables or fiber optic networks to set up the transmission network. The telecommunication distribution system also requires base station, exchange center and transmission lines to form a core network and access network, and the information is transmitted from the core network to the users' cell phones via the base station, and vice versa. In the Internet system, gateways, routers and transmission lines form an IP network, and the information is transferred to the server used by the user via the IP network, and the user accesses the information by means of connecting to the server.

The above existing information distribution mediums have the common disadvantages concerning a large expense at the primary construction stage, and an excessively high cost in operating the system, and the telecommunication system also has the fatal defect of insufficient bandwidth. These information distribution mediums all employ the terminal devices owned by the user (e.g., television, computer, cell phone), which further restricts their practicability.

### SUMMARY OF THE INVENTION

In order to solve the disadvantages in the conventional art, the present invention utilizes the public transit system (such as the public vehicle system, ferryboat system, mass rapid transit system and railway et al) as the information transmission mediums to avoid installing cables during the primary construction stage. Furthermore, the public transit system covers the living area of most of the people, which thus satisfies most peoples' demanding.

The information exchange of the present invention (besides the circumstance that Internet is used to broadcast the commerce client consigned information) preferably utilizes the wireless distribution. Since the long-distance distribution has been achieved by the public transit system, the short-distance distribution can be achieved by the wireless distribution, which utilizes the industrial scientific medical (ISM) channel (such as 2.4 GHz) together with the spread spectrum technique to transmit data. Being different from the wireless television distribution system and the telecommunication distribution system also using the wireless transmission, the system of the present invention using the ISM channel together with the spread spectrum technique does not need to apply for the managing department, but can be used by any one having the hardware devices, just like the currently prevailing wireless network, which is a significant advantage of the present invention as compared with the existing information distribution medium that can be operated only if a license is granted.

The present invention substantially comprises a public transit system, which comprises at least one transportation vehicle that can travel according to the predetermined route, wherein a movable wireless base station is disposed on each transportation vehicle for transmitting and receiving data; at least one information exchange center, located at a position where the transportation vehicle of the public transit system stops for a relatively long time (e.g., bus station); and at least one information station, located close to the travel route of the transportation vehicle, for being helpful for the data transmission.

The information exchange center receives information delivered via the Internet, and transmits the information to the movable wireless base station on the transportation vehicle in a wired or wireless manner when the transportation vehicle stops at the information exchange center. Then, when the transportation vehicle is close to the information stations, the information is transmitted to the information stations in a wired or wireless manner. Each of the information stations is capable of individually connecting to at least one extension information station (such as terminals in home or office or public places, and advertisement screens), so as to achieve the objective of information distribution network. The reverse information transmission for system management also is exists in the present invention.

Since it is difficult to control the time that the transportation vehicle stays at the information station and the information exchange center, the information may be divided into several segments (the information may also be divided into several segments in advance before it is transmitted) when the information is transmitted from the information exchange center to the movable wireless base station on the transportation vehicle, and from the movable wireless base station to the information station, and the information is recombined into a complete information within the information station. If there is more than one transportation vehicle, and they are close to each other when traveling around, the information can be exchanged between them. Currently, the tricks of the public transit systems in metropolis are dense, and thus the divided information can be completely collected by the information stations in a very short time period, and then recombined. The dividing and recombining processes are commonly seen in the data transmission of computer, which thus will not be described herein any more.

Furthermore, the transportation vehicle is a traffic tool that carries passengers, and the movable wireless base station may be further connected to a GPS module and a plurality of displays, so as to achieve the wired information searching and the traveling guide broadcasting network within the vehicle.

The installation of the present invention has a relatively low cost, and being different from the large-area television broadcasting, the present invention provides a small-scale local broadcasting service, and particularly, small-scale commercial firms may have intensive advertisement in several areas of the several bus lines (taking bus as an example), thereby achieving the truly “customized” advertisement service. Furthermore, the present invention is not only suitable for small area broadcasting, but also achieves the cross-area low cost broadcasting with the aids of the transportation vehicle such as railways.

### BRIEF DESCRIPTION OF THE DRAWINGS

FIG. 1 is a schematic view of an information distribution route according to the present invention;

FIG. 2 is a schematic structural view of an information exchange center according to the present invention;

FIG. 3 is a schematic structural view of a movable wireless base station according to the present invention;

FIG. 4 is schematic structural view of an information station according to the present invention;

FIG. 5 is a schematic structural view of an on-bus or on-boat wired information searching and traveling guide broadcasting network formed by combining the movable wireless base station of the present invention with a GPS and an externally-connected display; and

FIG. 6 is a schematic view of a broadcasting network formed by combining the information station with the extension information stations according to the present invention.

### DETAILED DESCRIPTION OF THE PREFERRED EMBODIMENTS

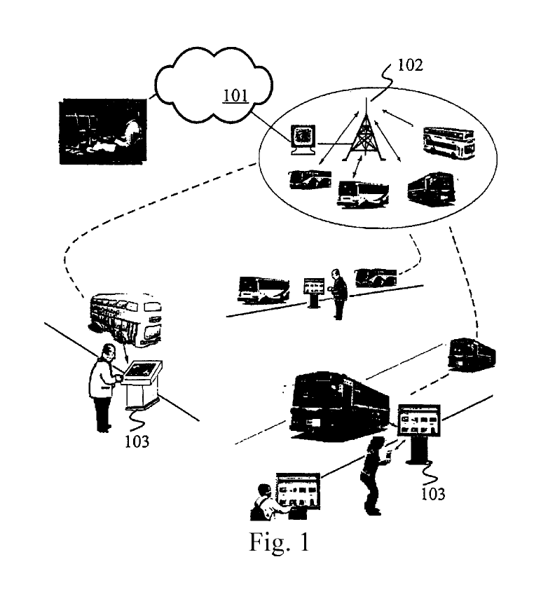

A specific embodiment of the present invention is shown in FIG. 1 to FIG. 6, which only illustrates the possible implementation of the present invention, so as to make the present invention be more comprehensible, but not intended to limit the implementation of the present invention. Definitely, several modifications of the implementation within the spirit and scope of the present invention may be made by those ordinarily skilled in the art.

Referring to FIG. 1, the information distribution system of the present invention includes: a public transit system, which has at least one transportation vehicle that travels along a predetermined route, wherein a movable wireless base station is disposed on each transportation vehicle; at least one information exchange center 102, which is located at a position where the transportation vehicle in the public transit system usually stops and stays for a relatively long time; and at least one information station 103, which is located close to the route that the transportation vehicle travels along;

The information exchange center 102 receives the information transmitted from a network 101, and transmits the information to the movable wireless base station on the transportation vehicle when the transportation vehicle stops at the information exchange center 102, and the information is transmitted to the information stations 103 when the transportation vehicle stops at the information stations 103. Each of the information stations 103 is connected to at least one extension information station, so as to achieve the object of information distribution network. The reverse information transmission for system management also is exists in the present invention.

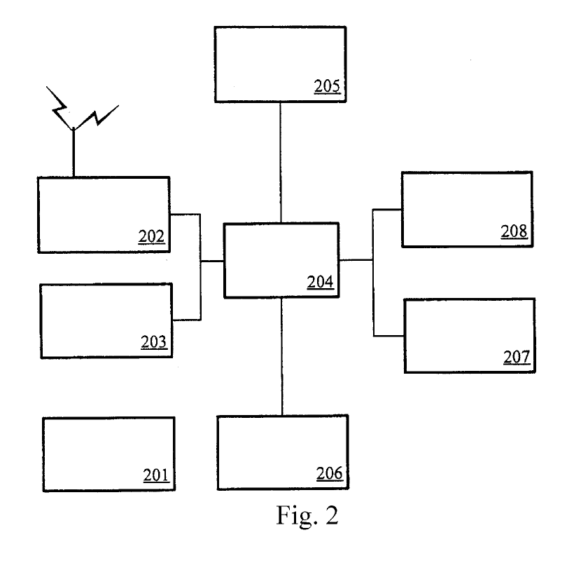

Referring to FIG. 2, the information exchange center 102 includes a heterogeneous network interfacing module 208 for providing a communication channel for receiving the information; a wireless receiving/transmitting module 202 for exchanging the information with the movable wireless base station in the transportation vehicle; a storage module 206 for temporally storing the information after receiving the information, which may be a hard disc or a non-volatile memory; a wired high-speed receiving/transmitting module 203 for exchanging the information with the movable wireless base station in the transportation vehicle; a central processing unit (CPU) 204 for managing the operation of the information exchange center 102; a memory module 205 for cooperating with the operation of the CPU 204; a power module 201 for providing the power required by the information exchange center 102; and a display and input module 207 for displaying or editing the received data.

Except the power module 201, other modules in the information exchange center 102 are all connected to the CPU 204, and the power module 201 is connected to each module to provide the power depending on the circuit designing requirements.

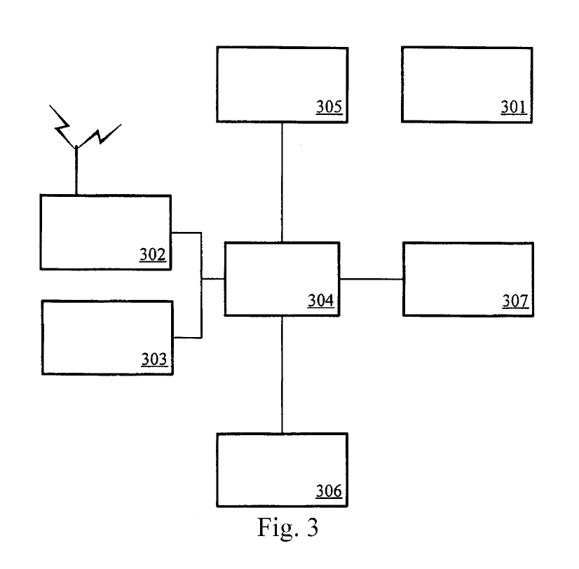

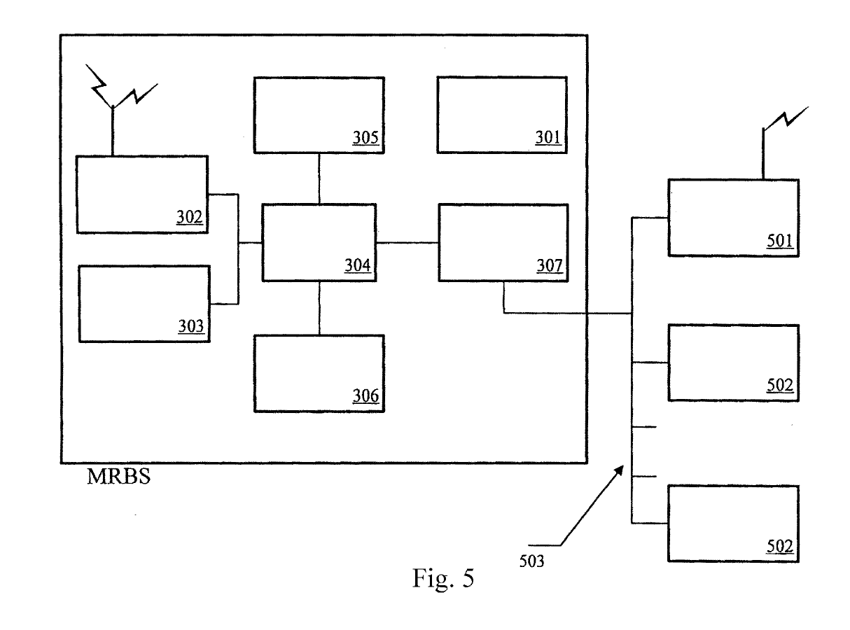

Referring to FIG. 3, the movable wireless base station includes: a wireless receiving/transmitting module 302 for receiving the information and transmitting the information to the information station 103; a storage module 306 for temporally storing the information after receiving the information, which may be a hard disc or a non-volatile memory; a wired high-speed receiving/transmitting module 303 for receiving the information and transmitting the information to the information station 103; a CPU 304 for managing the operation of the movable wireless base station; a memory module 305 for cooperating with the operation of the CPU 304; a power module 301 for providing the power required by the movable wireless base station; a distribution module 307 for distributing the received data and displaying the received data on the displays 502 in the transportation vehicles. Still referring to FIG. 5, the movable wireless base station is further connected to a GPS module 501, which is coupled with the data output by the distribution module 307, so as to display the current position and the information relevant to the position on more than one display 502 in the transportation vehicle.

Except the power module 301 and the GPS module 501, other modules within the movable wireless base station are all connected to the CPU 304, and the power module 301 is connected to each module to provide the power depending on the circuit designing requirements.

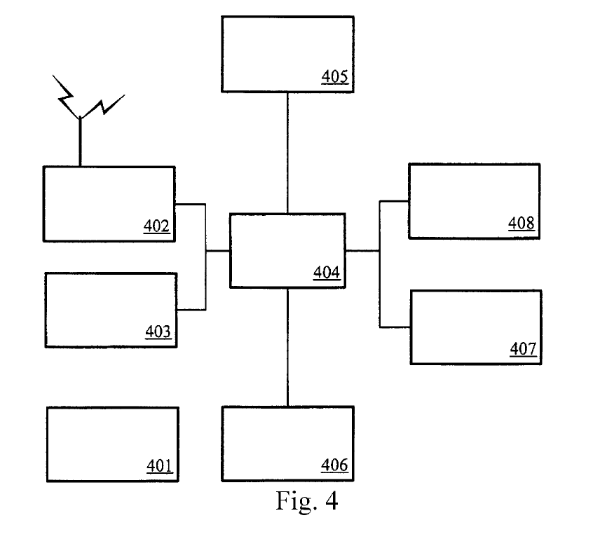

Referring to FIG. 4, the information station 103 includes: a wireless receiving/transmitting module 402 for exchanging the information with the movable wireless base station on the transportation vehicle; a storage module 406 for temporally storing the information after receiving the information; a wired high-speed receiving/transmitting module 403 for receiving the information from the movable wireless base station on the transportation vehicle; a CPU 404 for managing the operation of the information station 103; a memory module 405 for cooperating with the operation of the CPU 404; a power module 401 for providing the power required by the information station 103; a display module 407 for displaying the received data; and an extension module 408 for connecting and transmitting the data to more than one peripheral extension information station 607.

Except the power module 401, other modules within the information station 103 are all connected to the CPU 404, and the power module 401 is connected to each module to provide the power depending on the circuit designing requirements.

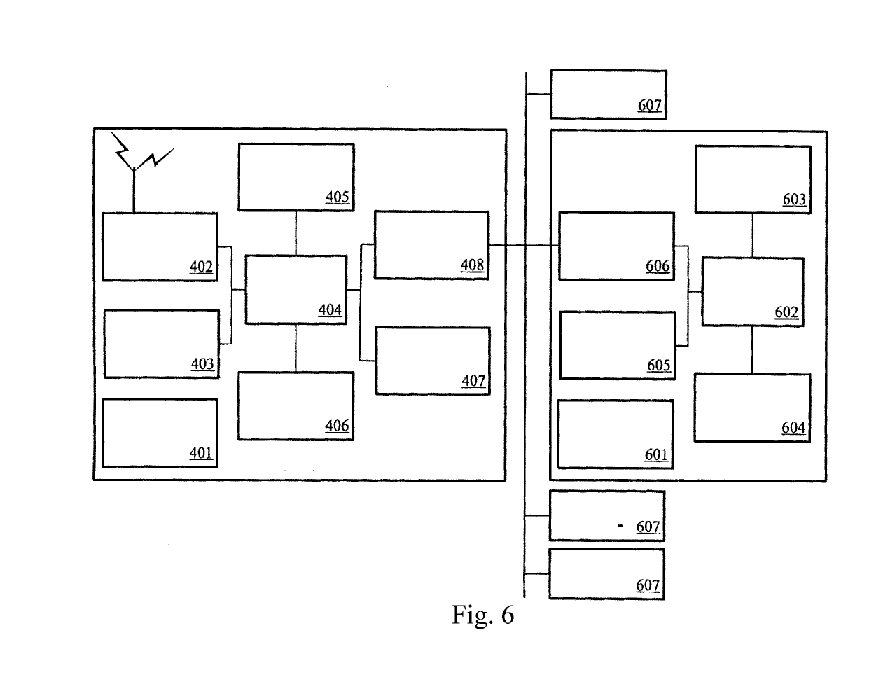

Referring to FIG. 6, it is a schematic architectural view of the information station 103 and the extension information station 607. The extension information station 607 includes: an extension module 606 for receiving the information from the information station 103; a display module 605 for displaying the received information; a CPU 602 for managing the operation of the extension information station 607; a memory module 603 for cooperating with the operation of the CPU 602; a storage module 604 for storing the information after receiving the information, which may be a hard disc or a non-volatile memory; and a power module 601 for providing the power required by the extension information station 607.

Except the power module 601, other modules within the extension information station 607 are all connected to the CPU 602, and the power module 601 is connected to each module to provide the power depending on the circuit designing requirements.

We claim:

1. An information distribution system, comprising:
a public transit system, having at least one transportation vehicle traveling according to a predetermined route, wherein a movable wireless base station is disposed on each of the transportation vehicles;
at least one information exchange center, located at a position where the transportation vehicle stops in the public transit system; and
at least one information station, located close to the travel route of the transportation vehicle, for being helpful for data transmission;
wherein the information exchange center receives the information, and transmits the information to the movable wireless base station on the transportation vehicle when the transportation vehicle stops at the information exchange center, and the information is transmitted to the information stations when the transportation vehicle is close to the information stations; each of the information stations is connected to at least one extension information station, and the reverse information transmission for system management also is exists in the present invention, thereby forming an information distribution network.

2. The information distribution system as claimed in claim 1, wherein the movable wireless base station at least comprises:
a wireless receiving/transmitting module, for receiving the information and transmitting the information to the information station;
a storage module, for temporally storing the information after receiving the information.

3. The information distribution system as claimed in claim 2, wherein the movable wireless base station further comprises:
a wired high-speed receiving/transmitting module, for receiving the information and transmitting the information to the information station;
a central processing unit (CPU), for managing operation of the movable wireless base station;
a memory module, for cooperating with the operation of the CPU;
a power module, for providing the power required by the movable wireless base station;
a distribution module, for distributing the received information and displaying the received information on displays within the transportation vehicles.

4. The information distribution system as claimed in claim 3, wherein the movable wireless base station is further connected to a GPS (Global Position System) module; the GPS module is coupled with the data output from the distribution module, so as to display the current position and the information relevant to the position on more than one output device within the transportation vehicle.

5. The information distribution system as claimed in claim 3, wherein except the power module, other modules in the movable wireless base station are all connected to the CPU, and the power module is connected to each module to provide the power depending upon the circuit design requirements.

6. The information distribution system as claimed in claim 4, wherein except the power module and the GPS module, other modules in the movable wireless base station are all connected to the CPU, and the power module is connected to each module to provide the power depending upon the circuit design requirements.

7. The information distribution system as claimed in claim 1, wherein the information exchange center at least comprises:
a heterogeneous network interfacing module, for providing a communication channel for receiving and transmitting the information;
a wireless receiving/transmitting module, for exchanging the information with the movable wireless base station within the transportation vehicle;
a storage module, for temporally storing the information after receiving the information.

8. The information distribution system as claimed in claim 7, wherein the information exchange center further comprises:
a wired high-speed receiving/transmitting module, for exchanging the information with the movable wireless base station within the transportation vehicle;
a CPU, for managing operation of the information exchange center;
a memory module, for cooperating with the operation of the CPU;
a power module, for providing the power required by the information exchange center;
a display and input module, for displaying or editing the received data.

9. The information distribution system as claimed in claim 8, wherein except the power module, other modules within the information exchange center are all connected to the CPU, and the power module is connected to each module to provide the power depending on the circuit designing requirements.

10. The information distribution system as claimed in claim 1, wherein the information station at least comprises:
a wireless receiving/transmitting module, for exchanging the information with the movable wireless base station on the transportation vehicle;
a storage module, for temporally storing the information after receiving the information.

11. The information distribution system as claimed in claim 10, wherein the information station further comprises:
a wired high-speed receiving/transmitting module, for exchanging the information with the movable wireless base station on the transportation vehicle;
a CPU, for managing operation of the information station;
an extension module, for connecting and transmitting data to more than one peripheral extension information station;
a memory module, for cooperating with the operation of the CPU;
a power module, for providing the power required by the information station;
a display module, for displaying the received data.

12. The information distribution system as claimed in claim 11, wherein except the power module, other modules within the information station are all connected to the CPU, and the power module is connected to each module to provide the power depending on the circuit designing requirements.

13. The information distribution system as claimed in claim 11, wherein the extension information station at least comprises:
an extension module, for receiving the information from the information station;
a display module, for displaying the received information.

14. The information distribution system as claimed in claim 13, wherein the extension information station further comprises:
a CPU, for managing operation of the extension information station;
a memory module, for cooperating with the operation of the CPU;
a storage module, for storing the information after receiving the information;
a power module, for providing power required by the extension information station.

15. The information distribution system as claimed in claim 14, wherein except the power module, other modules in the extension information station are all connected to the CPU, and the power module is connected to each module to provide the power depending on the circuit designing requirements.

16. A method of operating an information distribution system as claimed in claim 1, comprising:
the information exchange center receiving a whole part or a divided part of an information from the exterior of the distribution system;
during the time period that a transportation vehicle belonging to the information distribution system stops at the information exchange center, transmitting the whole part of the information depending upon the time period that the transportation vehicle stays for, or transmitting the divided part corresponding to the transmitting time to a movable wireless base station of the transportation vehicle;
when the transportation vehicle gets close to the information station, transmitting the whole part of the information depending on the transmitting time, or transmitting a divided part of the information corresponding to the transmitting time to the information station; and
setting the information to an available state after the information station determines that the information has been completely received, otherwise, not opening the information;

17. The method as claimed in claim 16, wherein the whole part of the information or the divided part of the information is transmitted to the information exchange center through an Internet.

18. The method as claimed in claim 16, wherein the information is transmitted from the information exchange center to the movable wireless base station of the transportation vehicle, and transmitted from the movable wireless base station of the transportation vehicle to the information station through wireless transmission or wired transmission.

19. The method as claimed in claim 16, wherein if there are more than one transportation vehicles, when they get close to each other, depending on a length of the transmission time data of the whole part of the information or the divided part of the information corresponding to the transmission time of the more than one transportation vehicles are wirelessly transmitted.

20. The method as claimed in claim 19, wherein the wireless transmission is achieved by utilizing an ISM frequency band and a spread spectrum technique.
